(19) United States
(12) Patent Application Publication
(10) Pub. No.: US 2016/0091007 A1
(43) Pub. Date: Mar. 31, 2016

(54) REMOVABLE BLIND-HOLE WIDE-EXPANSION WEDGE FASTENER

(71) Applicant: Michael J. Grassi, Columbus, OH (US)

(72) Inventor: Michael J. Grassi, Columbus, OH (US)

(73) Assignee: DYNO PRO LLC, Brooklyn, OH (US)

(21) Appl. No.: 14/869,164

(22) Filed: Sep. 29, 2015

Related U.S. Application Data
(60) Provisional application No. 62/057,576, filed on Sep. 30, 2014.

(51) Int. Cl. F16B 13/04

(52) U.S. Cl. CPC F16B 13/04; F16B 2013/10

(57) ABSTRACT

A removable and selectively radially expandable fastener device includes a body and at least one expanding arm located on each end of the body. The at least one arm on each end of the body is selectively moveable radially in relation to a longitudinal axis of the body. Such movement can be manually activated by rotating a fastener or torsion member, thus moving a washer axially to rotate the at least one arm radially.

This application claims the benefit of Provisional Application Ser. No. 62/057,576 which was filed on Sep. 30, 2014. The entire content of that application is incorporated hereinto by reference.

### BACKGROUND

A removable fastener device is shown and described which permits the fastener to be installed in a hole or bore having at least two diameters. The opening to the hole or bore can have a smaller diameter than is a diameter of the remainder of the hole or bore, such as in a blind hole. But, the constriction in the hole diameter can also be at another location than at the entrance to the hole. That is, the hole can have at least two diameters. The removable fastener device is especially well suited for electronics or the like, where the body of the fastener may be sensitive to torsional, axial, and bending loads; or the combination of such loads; and, where the body of the fastener device is needed for purposes other than for mounting the fastener device itself, such as for forming a canister for housing components that can occupy or make use of the fastener's center axis versus a shorter chord length across the diameter of the canister.

An example of an apparatus that would benefit from the fastener device disclosed herein is one embodiment of the sensor described in U.S. Pat. No. 9,097,598. That patent is entitled Torque Sensor and issued on Aug. 4, 2015. The subject matter of that patent is incorporated herein by reference in its entirety. Described in one embodiment of that patent is a carrier (fastener/torque sensor) that fits inside a bicycle crank spindle (blind hole). Current cycle crank sets made by several manufacturers including FSA of Mukilteo, Washington, Shimano of Sakai, Japan, SRAM of Chicago, Illinois and others have hollow crank set spindles with inside diameters which vary along the spindle's axis, most notably towards one of the spindle ends, where a bolt may be used to fasten a crank arm to the spindle. This bolt hole is typically of a smaller diameter than is the spindle internal diameter. Thus, a fastener device must first pass through a small diameter opening before entering a hole having a larger diameter.

U.S. Pat. No. 9,097,598 describes various direct approaches, indirect approaches, and removable fasteners for attaching the carrier sensor to the inside of the spindle. Direct approaches such as welding and swaging are advantageous as these means are the most rigid. Their disadvantage, however, is that these means are permanent like gluing, and the mating blind hole diameter and fastener component need to be very close in size. Indirect methods are also advantageous, but for modularity have the disadvantage of being more expensive. Removable fasteners of fastener devices are probably the most advantageous as they would present the greatest modularity and adaptability. Being removable versus being welded or glued in place is advantageous as bike shops do not want to have to install a component which is not removable. Non-removable items are best left to the manufacturing environment.

Further, some spindles, most notably those made by Shimano have two internal diameters, the opening diameter being smaller than the diameter, of the rest of the hollow interior of the spindle. This presents a significant issue in removably fastening an item inside the spindle, as the spacing or gap is large. A simple expansion bolt that is commonly employed on stems of bicycles may be employed in some cranksets having a hole of the same diameter, or at least a larger opening diameter than that of a blind hole. One disadvantage of such a fastener is that it will not work with a blind hole having a smaller diameter opening. A further the disadvantage with this style of expansion bolt is that this fastener type requires a bolt to run down the center (or near center) of the fastener device carrier/ torque sensor. This is a disadvantage as components such as electronic boards then have to be reduced in width and made longer since the board has to be placed off the center axis. Yet further, the device itself may be delicate and thus high torsional and compression loads are imparted to the fastener device's body when the bolt is used to squeeze the expanding portions of the fastener, and that may not be desirable.

Thus, there exists a need for a fastener device which substantially reduces the torsional, bending, and axial loads to the fastener's central body; is able to be fastened into a blind hole having a first opening which is smaller than the diameter of the blind hole itself and with the fastener being able to expand to the larger diameter of the blind hole; and where the axis of the center portion along the length of the fastener's body is able to be used for other purposes, such as housing electronics or the like.

The present exemplary embodiments provide an improved fastener device which overcomes the above-referenced problems and others.

### BRIEF SUMMARY

A removable and selectively radially expandable fastener device includes a body and at least one expanding arm located on each end of the body. The at least one arm on each end of the body is selectively moveable radially in relation to a longitudinal axis of the body. Such movement can be manually activated by rotating a fastener, thus moving a washer axially to rotate the at least one arm radially.

According to one embodiment of the present disclosure, a selectively radially expandable fastener device comprises a body having a first end and a second end. At least two first arms are pivotably mounted at the first end of the body, the at least two first arms are radially expandable in relationship to a longitudinal axis of the body from a first position. A first wedge washer mounted to the body is adapted to pivot the at least two first arms radially outwardly from the first position to a second position. At least two second arms are disposed at the second end of the body. The at least two second arms are radially expandable in relation to the longitudinal axis from the first position. A second wedge washer mounted to the body is adapted to pivot the at least two second arms radially outwardly from the first position to the second position.

According to another embodiment of the present disclosure, there is provided a selectively radially expandable and contractible fastener device which is adapted to be selectively installed in a bore. The fastener device comprises a body having a first end, a second end, a longitudinal axis and an exterior periphery. At least two first arms are disposed adjacent the first end of the body, the at least two first arms each include a base and a tip. At least two second arms are disposed adjacent the second end of the fastener body, the at least two second arms each including a base and a tip. The at least two first arms and at least two second arms are operable to rotate radially outwardly in relation to the longitudinal axis of the body to frictionally engage the fastener device with a wall surface of a bore, thereby wedging the fastener within the bore.

According to yet another embodiment of the present disclosure, there is provided a method for securing a fastener in a bore. The method comprises providing a fastener body including a first set of radially expandable arms located adjacent one end of the fastener body and a second set of radially expandable arms located adjacent the other end of the fastener body with each set of radially expandable arms including a respective wedge member and a respective torsional member. The torsional member of the first set of radially expandable arms is tightened, thereby drawing the wedge member toward the fastener body and rotating the first set of radially expandable arms outwardly from the fastener body until the first set of radially expandable arms frictionally engage a wall surface defining the bore. Then, tightening the torsional member of the second set of radially expandable arms thereby drawing the second wedge member with the fastener body and rotating the second set of radially expandable arms outward from the fastener body until the second set of radially expandable arms frictionally engages the wall surface defining the bore.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1 is a perspective view of a fastener device according to a first embodiment of the present disclosure along the axis of an associated blind hole spindle with the fastener of the present disclosure being shown during the process of being installed;

FIG. 2 is a perspective view along the axis of an associated blind hole spindle with the fastener of FIG. 1 being positioned inside a hollow interior of the spindle and in an installed position;

FIG. 3 is an end elevational view of the fastener device of FIG. 2 normal to the axis of the associated blind hole spindle opening showing how access is gained to the front and rear fasteners;

FIG. 4A is an enlarged fragmentary end elevational view of the fastener device of FIG. 1;

FIG. 4B is a side elevational view of the fastener device of FIG. 4a with a central portion broken away and without the arm shown in FIG. 4A;

FIG. 5 is an end elevational view of the fastener device according to another embodiment of the present disclosure from one end thereof;

FIG. 6 is a perspective view of the fastener device of FIG. 5 before it is installed in a bicycle spindle; and

FIG. 7 is a perspective view of a fastener device according to still another embodiment of the present disclosure, the fastener device being configured to be expanded from two directions.

### DETAILED DESCRIPTION

It is to be understood that the detailed figures shown herein are for purposes of illustrating exemplary embodiments of the present disclosure only. They are not intended to be limiting. Additionally, it will be appreciated that the drawings are not to scale and that portions of certain elements may be exaggerated for the purpose of clarity and ease of illustration.

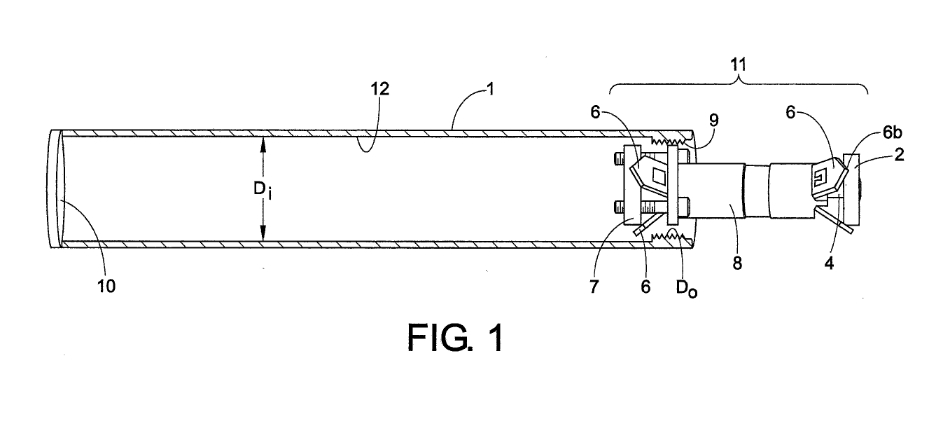

FIG. 1 shows a removable fastener device 11, hereafter referred to as device 11 just prior to fully entering an associated bicycle spindle 1 having a blind end 10. As shown, the device 11 is about to enter a spindle opening 9 which opening has a smaller diameter (Do) than is an inner spindle diameter (Di) shown at location 12.

The device 11 itself includes a body 8 which is provided with expandable arms 6 located at or adjacent each end of the device 11. In the embodiment shown, each end has three arms 6 which cooperate to form a tripod arrangement. It should be appreciated, however, that two arms 6 will also work. So, too, would four or more arms. The expandable arms 6 at or adjacent each end are shown as all being equal in size, shape, and length, however they need not be. The expandable arms 6 are positioned so that a tip 6b of each arm, being the most radially outward portion thereof will fit through the spindle opening 9.

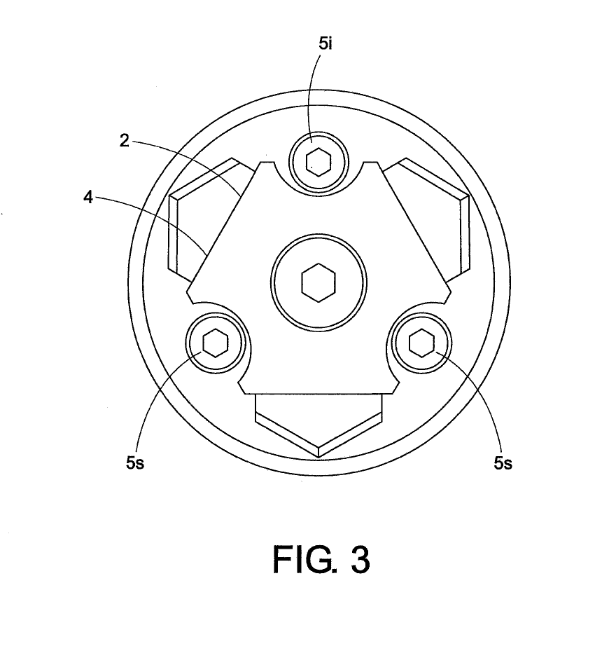

The arms 6 need not be permanently attached to the body 8, but may be separate parts so as to permit use of a material for the arms which is different from the material used for the body 8. The arms 6 act to wedge the body 8 within the associated spindle 1, and thereby fasten the device 11 in place in the hollow interior of the spindle. The respective arms 6 mounted to or adjacent each end of the body 8 are expanded, respectively, by a front wedge washer 2 and a rear wedge washer 7. The arms 6 are shown in FIG. 1 as being positioned away from but aligned with a longitudinal axis of the body 8 so that the arms 6 can pass through the spindle opening 9. Front wedge washer 2 is more clearly seen in FIG. 3 as having, in this embodiment, a triangular shape (as an arm 6 is used for each side of the triangle). The wedge washer however need not be triangular, but geometrically would take on a shape based on the number of arms 6 used (for each side of body 8). That is, if four arm 6 are used, the wedge washer shape would be a square, having a side for each arm 6.

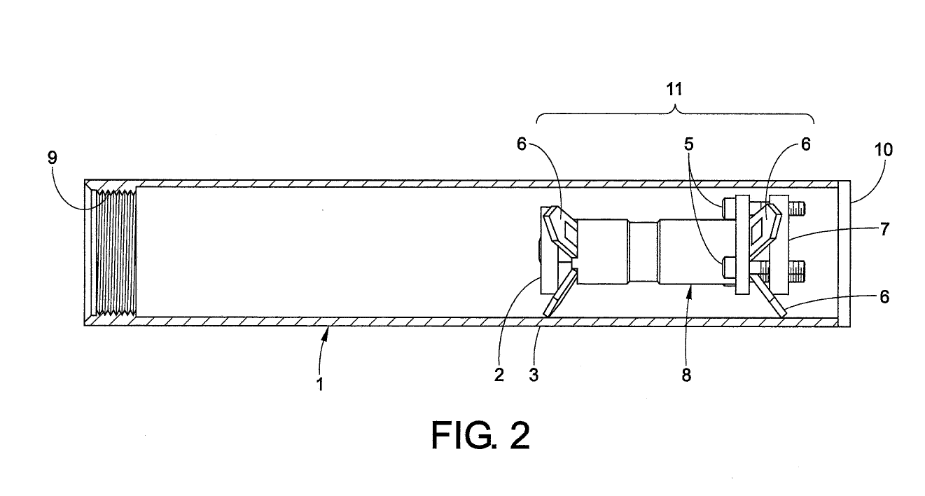

Referring to FIG. 2, the device 11 is shown as being located within the spindle 1 having a larger internal diameter than an opening diameter, i.e., Di >Do. The arms 6 on each end of the body 8 are now shown as having been expanded by both the front wedge washer 2 and the rear wedge washer 7 to contact an interior surface of the bore defined in the spindle. This has been accomplished by drawing both the front wedge washer 2 and rear wedge washer 7 towards body 8. Each wedge washer 2, 7 is axially moved towards each respective end of the device 8 by one or more fasteners. In the embodiment shown in FIG. 3, these are a single front fastener 4 and several rear fasteners 5. These are shown as being threaded. However, fasteners 4, 5 need not be threaded, so long as they are movable. Threaded fasteners, which can also be called torsion members, are used in the description of the first embodiment as these type of fasteners impart torsional forces, and facilitate in describing this embodiment of the disclosure. FIG. 3 shows a normal view looking down the open end of the spindle 1 axis. The fasteners 4, 5 are all accessible and are able to be tightened or loosened from the spindle opening 9.

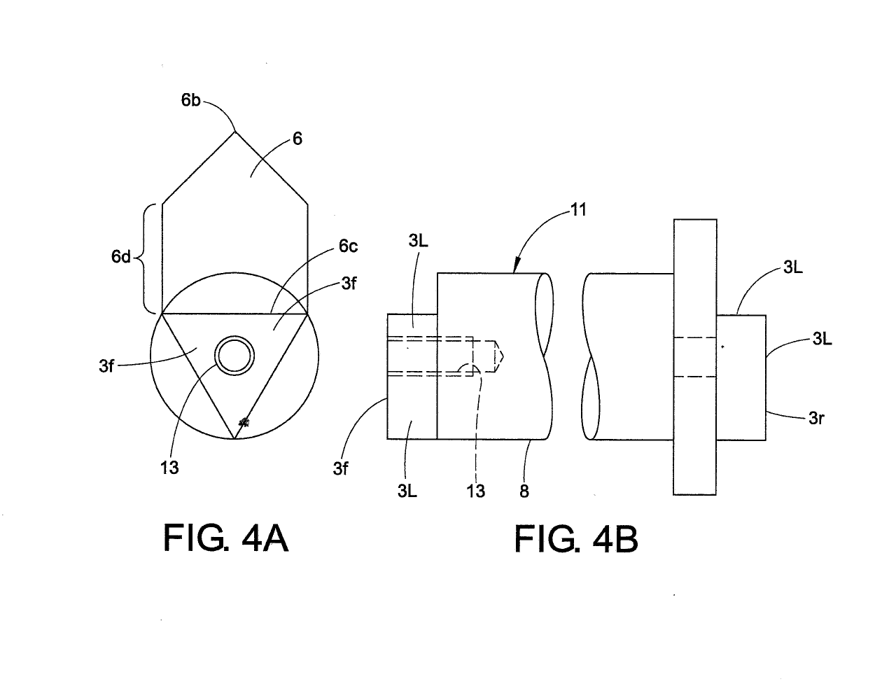

Referring back to FIG. 2, as the front or proximal wedge washer 2 is drawn towards the body 8 by tightening fastener 4, the wedge washer 2 causes arms 6 to expand radially outwardly away from the axis of body 8 by wedging. Likewise, as fasteners 5 are tightened, rear or distal wedge washer 7 is drawn toward body 8 causing arms 6 to expand radially outwardly as well. Fasteners 4, 5 can and may have a combination of either right or left handed threads depending on the device. For the description of this embodiment, all will be described as having right hand threads. Note that fasteners 5 are mounted on a different bolt circle diameter than is fastener 4. Fastener 4 is centrally located on the fastener main body 8. However, it extends only for a short distance as shown in FIG. 4B, i.e. the fastener 4 does not pass down the bore/axis of the entire device 8. Rather, the fastener 4 only needs enough hole 13 to move front wedge washer 7 as better shown in FIGS. 4A and 4B. Tightening fastener 4 first causes very little torsion (moment) during tightening on the body 8 of device 11 once arms 6 frictionally engage the spindle 1 as reaction torque to the body 8 is confined to the front ‘ledge nut face’ 3f portion of device 8 which is shown in FIGS. 4A and 4B. Thus little to no torsional force remains on main body 8 of the device 11 after tightening fastener 4 first.

Second, fasteners 5 are tightened. Note that turning fasteners 5 alone is technically a ‘couple’ and thus not a moment force with respect to a point. That is, the couple does not itself impart a torque to the device 11. However, being that the hole is blind, a non-captive nut (not shown) is not possible. Therefore, as shown, the rear wedge washer 7 is threaded for each fastener 5. As the fastener 5 is tightened, the reaction torque from the rear wedge washer 7 is such as to oppose the couple, but in doing so imparts a minimal torque to device 11 until such time that arms 6 frictionally engage an interior wall surrounding the bore in the spindle 1. This reaction torque to device 11 during tightening one of the fasteners 5i is a result of the other two fastener 5s (FIG. 3) preventing rear wedge washer 7 from turning. The reaction torque is thus a function of the bolt circle diameter.

For the layman, the simplest way to understand the concept is to visualize making the bolt circle diameter extremely large. One can then more easily see that having fasteners 5 located on a large bolt circle diameter significantly reduces a torsion to the device 11 as fasteners 5 are tightened. Once arms 6 frictionally engage the spindle, the majority of the reaction torque is relieved from the main body 8 of the device 11 by the rear ‘ledge nut face’ 3r shown in FIG. 4B which for purpose of clarity and description of this embodiment can have the same geometry as the front ‘ledge nut face’ 3f shown in FIGS. 4a, 4b shown as three ledges 3L in a triangular pattern. In an embodiment having two arms per side (not shown), only a two ledge nut face having two ledges would be needed for the front wedge washer, and two ledges for the rear wedge washer. As described earlier, if four arms were provided the pattern would likely be rectangular so that four ledges may be present, i.e. a ledge is needed for each arm.

Further, additional numbers of fasteners 5 can benefit the fastener device since torsion to the device is further reduced due to less torque from each of the additional fasteners. For example, in the embodiment shown, the wedging action/force on the rear wedge washer 7 to cause the arms 6 to expand is from three fasteners 5 versus the one fastener 4 employed on the front wedge washer 2. Therefore, the tightening torque (assuming all fasteners are equal) on each fastener 5 is based on the quantity of fasteners 5. In the present example, the torque (couple) to each fastener 5 is thus one third that of fastener 4 in order to achieve the same wedging action on the rear wedge washer 7 as that on the front wedge washer 2.

Arms 6 can be made part of device 8 such that arms 6 can be made to rotate outwardly, like a tripod (in order to engage different spindle diameters and expand beyond the spindle opening diameter) , but can support a torsion from the spindle to the device 11. To support a torsion, the base 6c (see FIG. 4A) of the respective arm 6 must be able to support at least a compression load caused by the spindle 1 twisting. In the present embodiment, the ‘ledges nut faces’ 3r, 3f provide this feature. In one embodiment, the arms 6 are separate from device 8 as this allows different geometries to arm tips 6b to be used for frictional engagement. In some cases, an arm tip 6b that is sharp may be desired for high hardness materials. On the other hand, a dull to blunt tip may be advantageous for low hardness materials. Allowing different arm length 6d sizes is contemplated to accommodate spindles with different internal diameters. Further, this allows the arms 6 in the front and rear of the body 8 to be of at least two different length 6d sizes to facilitate fastening of the device 11 even in tapered diameter holes. It also allows a mixture of length sizes for either or both front and rear. Arms 6 can be stuck with adhesive to ledge nut faces 3r, 3f, rubber banded, or the like to body 8 to facilitate both assembly and installation prior to installation and wedging in the spindle 1, so that arms 6 do not fall out due to gravity etc.

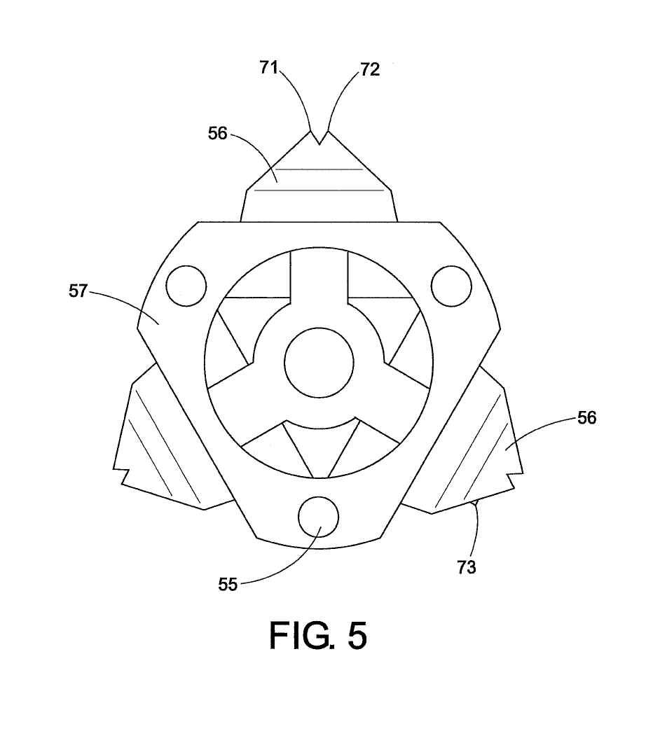

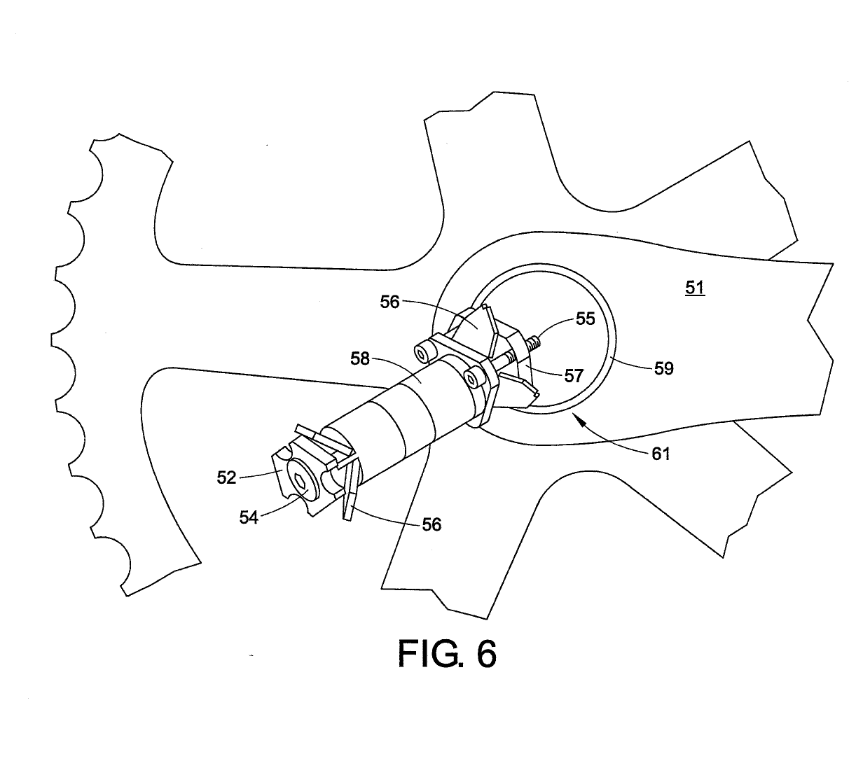

In accordance with another embodiment of the present disclosure and with reference now to FIGS. 5 and 6, there is provided a fastener device 61 which is meant to be installed in a bore of a spindle 51. More particularly, the fastener device 61 is meant to be inserted in a blind hole 59 of the spindle 51. In this embodiment, the fastener device comprises a body 58 having expandable arms 56 located at each end thereof. At a distal end, there are provided three arms 56 in this embodiment. The several arms 6 are located on each side of the body 8 and are expanded by a front or distal wedge washer 57 into engagement with an interior side wall or surface of the spindle bore. In this embodiment, the distal wedge washer 57 can be triangular in shape so as to interact correctly with the three pivotable arms 56. In order to move the distal wedge washer 57, there are provided three fasteners 55 which are threadedly received in bores in the distal wedge washer 57. By rotating the fasteners 55, one can pull the wedge washer 57 towards a flange 63 defined on the body 58 on which the several fasteners 55 are mounted. With continued reference to FIG. 6, also provided is a proximal washer 52 which engages proximal arms 56. The proximal washer 52 is connected to a proximal fastener 54. Rotation of the proximal fastener 54 will urge the washer 52 towards the body 58, thereby pivoting radially outwardly the arms 56 to bring them into engagement with an interior surface of the spindle.

It should be appreciated that the proximal fastener 54 can be rotated by a suitable implement such as a flat head or Philips head screw driver. On the other hand, the distal fasteners 55 can be rotated by an Allen wrench or the like, if so desired. It should be appreciated that there are a variety of suitable implements or tools which are capable of moving or rotating fasteners extending through or cooperating with distal and proximal washers or wedge washers. It should also be appreciated that the proximal washer 52 is so configured as to allow access for the tool meant to rotate the distal fasteners 55.

With reference now also to FIG. 5, in this embodiment, the expandable arms 56 are provided with a plurality of spaced tips 71, 72 and 73. In this way, the arms will dig into the metal of the spindle 51 at three different locations and, thus, strongly engage the spindle at the three separate tips 71, 72, 73 thereof, so as to hold the body 58 in place.

The disclosure as described is most suitable for a fastener assembly especially a fastener device where the body itself may include or house a torque sensor or which houses sensors that measure the twist of an associated spindle, and thus need to be fastened internal to the associated spindle. The above described disclosure resolves these needs. As noted, in one embodiment the arms 6 are detachable, so that fasteners can be made to fit many different spindle diameter sizes as well fastening to associated blind holes of different materials, ranging from very soft materials such as carbon fiber, to maranging steels with extremely high hardness.

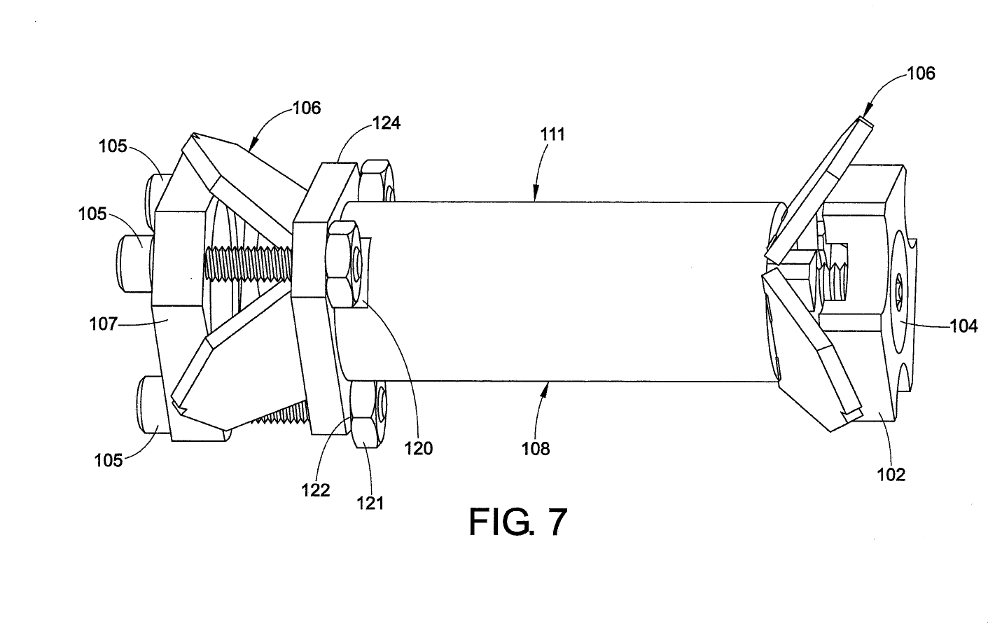

FIG. 7 shows a perspective view of a fastener device 111 according to still another embodiment of the present disclosure. In this embodiment, the fastener device 111 is modified to allow installation for a two piece spindle. One such spindle is made by Campagnolo of Vicenza, Italy having a Hirth joint (namely, a joint which connects two pieces of a shaft together and is characterized by tapered teeth that mesh together on the end faces of each half shaft) which has a small hole in the joint. Fastener device 111 would have to be inserted in the opposite manner, where a fastener 104 first would enter the ‘blind hole’. In this case, fasteners 105 would not be able to be tightened. But, fastener 104 can be tightened because of the small hole in the Hirth joint. In the case of Campagnolo cranks, the fastener device 111 has a different construction so that the device 111 can be tightened from two sides.

This can be accomplished because the rear or distal wedge washer shown in the embodiment of FIG. 1 is replaced with a rear wedge washer 107, shown in FIG. 7, having clearance holes for fasteners 105. Fasteners 105 are reversed in direction. As shown in FIG. 7, nuts 121 are provided for fastener 105. In the embodiment of FIGS. 1-2, although not specifically shown, clearance hole 122 in FIG. 7 was not threaded. Although a threaded hole for fastener 105 can be provided in a fastener body or housing 108, this would require an additional modified device 111 to be made or additional size fasteners 105 to be used. Alternatively, a flat 120 and nut 121 can be used as shown in FIG. 7, where flat 120 prevents nut 121 from turning. It should be appreciated that the nuts 121 are supported on a flange 124 defined on the distal end of the housing 108.

It is noted that wedge washer 107 can be altered by drilling out threads. This provides a low cost solution and makes the device 111 more versatile as many spindles do not have a blind hole, and thus tightening from both front and rear can be more easily facilitated by the configuration shown in FIG. 7 while retaining the ability of the fastener device 111 to be installed in a blind hole.

The exemplary embodiments of the disclosure have been described herein. Obviously, modifications and alterations will occur to others upon reading and understanding the preceding detailed description. It is intended that the instant disclosure be construed as including all such modifications and alterations insofar as they come within the scope of the appended claims or the equivalents thereof.

1. A selectively radially expandable fastener device comprising:
a body having a first end and a second end;
at least two first arms pivotably mounted at the first end of the body, the at least two first arms being radially expandable in relation to a longitudinal axis of the body from a first position;
a first wedge washer adapted to pivot the at least two first arms radially outwardly from the first position to a second position;
at least two second arms disposed at the second end of the body, the at least two second arms being radially expandable in relation to the longitudinal axis of the body from the first position; and
a second wedge washer adapted to pivot the at least two second arms radially outwardly from the first position to the second position.

2. The fastener device of claim 1, wherein the first position of the at least two first and second arms permits the fastener to pass through a hole in a body which hole has a smaller diameter than is a diameter of a bore in the body and the second position of the at least two first and second arms at the first and second ends of the fastener body wedges the fastener within the bore in the body and retards movement therein.

3. The fastener device of claim 2, wherein the front wedge washer has a shape defined by a number of ledges, wherein the number of ledges defining the shape of the front wedge washer corresponds to the number of arms disposed on the first end of the fastener body.

4. The fastener device of claim 1 further comprising a first fastener coupled to the first wedge washer for selectively moving same and a second fastener coupled to the second wedge washer for selectively moving same.

5. The fastener device of claim 4, wherein the rear wedge washer has a shape defined by a number of ledges, wherein the number of ledges defining the shape of the rear wedge washer corresponds to the number of arms disposed on the second end of the fastener body.

6. The fastener device of claim 1 further comprising a front torsion member for drawing the front wedge washer toward the first end of the fastener body, the front torsion member being centrally located on the fastener body.

7. The fastener device of claim 1 further comprising a rear torsion member for drawing the rear wedge washer toward the second end of the fastener body.

8. The fastener device of claim 7, further comprising a plurality of rear torsion members, the number of rear torsion members corresponding to the number of arms disposed on the second end of the fastener body.

9. The fastener device of claim 8, wherein the plurality of rear torsion members are disposed circumferentially around the fastener body to define a bolt circle diameter.

10. The fastener device of claim 1, wherein at least some of the first and second arms have a sharp tip.

11. The fastener device of claim 1, wherein at least some of the first and second arms have a blunt tip.

12. The fastener device of claim 1, wherein at least some of the first and second arms are selectively mounted to the fastener body.

13. The fastener device of claim 1, wherein the at least two first arms have a length different than is a length of the at least two second arms to accommodate the fastener is a bore having a tapered diameter.

14. The fastener device of claim 1, wherein the at least two arms of the first and second ends of the fastener body further comprise a base capable of supporting of a compression load.

15. The fastener device of claim 1, wherein the at least two arms of the first and second ends are made from a material different from a material of the fastener body.

16. The fastener device of claim 1, wherein the fastener body houses a sensor for measuring a twist of an associated hollow spindle in which the fastener body is disposed.

17. A removable and selectively radially expandable and contractible fastener device adapted to be installed in a bore comprising:
a body having a first end, a second end, a longitudinal axis and an exterior periphery;
at least two first arms disposed adjacent the first end of the body, the at least two first arms each including a base and a tip;
at least two second arms disposed adjacent the second end of the body, the at least two second arms each including a base and a tip;
wherein the at least two first arms and the at least two second arms are operable to rotate radially outwardly in relation to the longitudinal axis of the body to frictionally engage in a side wall defining the bore, thereby wedging the fastener within the bore.

18. The fastener of claim 17, wherein the body comprises a torque sensor.

19. The faster of claim 17, further comprising a wedge mechanism for rotating the at least two arms of the first and second ends outwardly from their base.

20. A method of securing a fastener device in a bore, the method comprising:
providing a fastener body including a first set of radially expandable arms located adjacent a first end of the fastener body and a second set of radially expandable arms located adjacent a second end of the fastener body, each set of radially expandable arms including a wedge member and a torsional member;
tightening the torsional member of the first set of radially expandable arms, thereby drawing the wedge member toward the fastener body and rotating the first set of radially expandable arms outward from the fastener body until the first set of radially expandable arms frictionally engages a wall surface defining the bore; and
tightening the torsional member of the second set of radially expandable arms, thereby drawing the wedge member toward the fastener body and rotating the second set of radially expandable arms outward from the fastener body until the second set of radially expandable arms frictionally engages the wall surface defining the bore.
